(19) United States
(12) Patent Application Publication
(10) Pub. No.: US 2020/0311780 A1
(43) Pub. Date: Oct. 1, 2020

(54) INFORMATION PROCESSING APPARATUS, NON-TRANSITORY COMPUTER READABLE MEDIUM, AND METHOD

(71) Applicant: HONDA MOTOR CO.,LTD., Tokyo (JP)

(72) Inventors: Toshiaki TAKANO, Tokyo (JP); Mafuyu KOSEKI, Tokyo (JP); Takashi YAMADA, Tokyo (JP); Satoshi ONODERA, Tokyo (JP)

(21) Appl. No.: 16/828,983

(22) Filed: Mar. 25, 2020

(30) Foreign Application Priority Data
Mar. 29, 2019 (JP) 2019-069340

(51) Int. Cl. G06Q 30/02; G06K 9/00

(52) U.S. Cl. CPC G06Q 30/0282; G06Q 50/30; G06K 9/00832

(57) ABSTRACT

An apparatus comprises an evaluation acquiring unit that acquires information indicating an evaluation of a person and information indicating an activity condition of the person during an evaluation target interval, in association with each other. The person may be a passenger of a moving body. The evaluation target interval may be an interval during which the person rode in the moving body. The information indicating the evaluation may include information indicating a result obtained by another person who rode in the moving body during the evaluation target interval evaluating the person. The activity condition may include at least one of information indicating whether the person rode alone in the moving body and information indicating whether the person rode with a related person in the moving body.

The contents of the following Japanese patent application are incorporated herein by reference: No. 2019-069340 filed in JP on Mar. 29, 2019.

### BACKGROUND

### 1. Technical Field

The present invention relates to an information processing apparatus, a non-transitory computer readable medium, and a method.

### 2. Related Art

A carpooling support system is known that can increase the appearance rate of carpooling partners presented to carpooling applicants and increase the carpooling opportunities. Patent Document 1: Japanese Patent Application Publication No. 2015-035044

The summary clause does not necessarily describe all necessary features of the embodiments of the present invention. The present invention may also be a sub-combination of the features described above.

### BRIEF DESCRIPTION OF THE DRAWINGS

FIG. 1 schematically shows an example of a system configuration of an evaluation system 100.

FIG. 2 schematically shows an example of an internal configuration of the management server 110.

FIG. 3 schematically shows an example of an internal configuration of the evaluation registering unit 236.

FIG. 4 shows an example of a computer 3000 in which aspects of the present invention may be wholly or partly embodied.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention. In the drawings, identical or similar portions are given the same reference numerals, and redundant descriptions may be omitted.

[Outline of the Evaluation System 100]

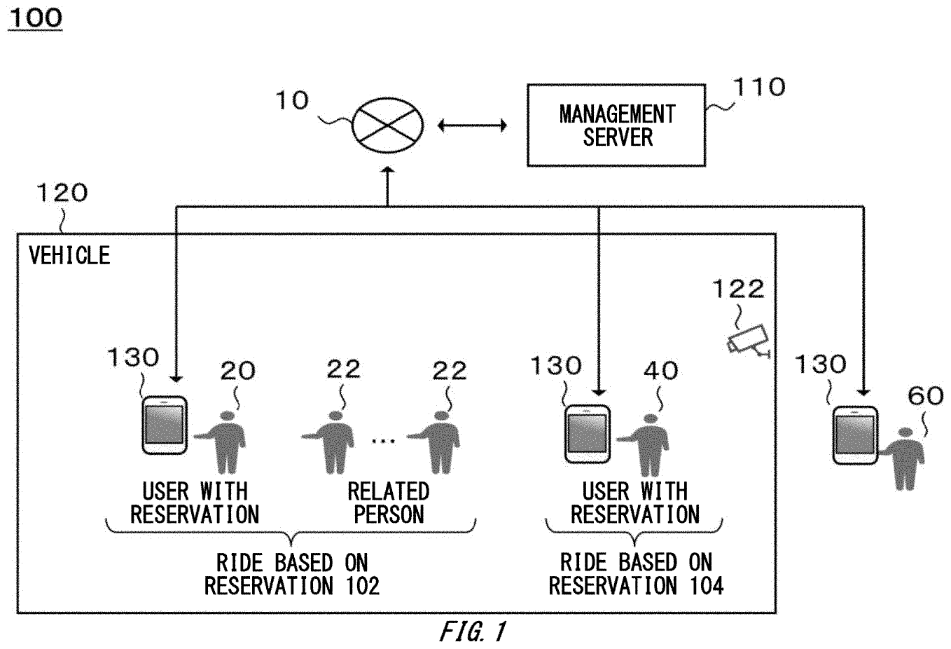

FIG. 1 schematically shows an example of a system configuration of an evaluation system 100. In the present embodiment, the evaluation system 100 includes a management server 110. The evaluation system 100 may include a vehicle 120. A vehicle-cabin imaging unit 122 may be arranged in the vehicle 120. Furthermore, the evaluation system 100 may include a communication terminal 130 that is used by a user (e.g. a user 20, a user 40, or a user 60) who uses the vehicle 120. All units of the evaluation system 100 may transmit and receive information to and from each other via a communication network 10.

In the present embodiment, the user 20 makes a reservation (sometimes referred to as a reservation 102) for using the vehicle 120, to the management server 110. In the reservation 102, it is determined that the user 20 and a related person 22 of the user 20 are to ride in the vehicle 120. Similarly, the user 40 makes a reservation (sometimes referred to as a reservation 104) for using the vehicle 120, to the management server 110. In the reservation 104, it is determined that the user 40 is to ride the vehicle 120 alone.

According to the present embodiment, the user 20, the related person 22, and the user 40 share the vehicle 120 over a prescribed interval. In the present embodiment, at least one of the user 20 and the user 40 may evaluate the other, and transmit information indicating the result of this evaluation to the management server 110.

For example, the user 20 provides the management server 110 with information indicating an evaluation concerning the user 40, for the interval during which the user 40 rode in the vehicle 120. The user 40 reports, to the management server 110, information indicating an evaluation concerning at least one of the user 20 and the related person 22, for the interval during which the user 20 rode in the vehicle 120. In the management server 110, the evaluation concerning the related person 22 may be treated as an evaluation concerning the user 20.

In the present embodiment, a user 60 accesses the management server 110 and acquires information concerning an evaluation of another user. For example, if the user 60 wants to ride in the vehicle 120, the user 60 browses the evaluations of other passengers of the vehicle 120, and determines whether to make a reservation to ride in this vehicle 120 based on these evaluations.

[Outline of Each Unit of the Evaluation System 100]

In the present embodiment, the communication network 10 transmits information between each unit of the evaluation system 100. The communication network 10 may be may be a transmission path for wired communication, a transmission path for wireless communication, or a combination of these. The communication network 10 may include a wireless packet communication network, the Internet, a P2P network, a dedicated line, a VPN, a power line communication line, a vehicle-to-vehicle communication network, a road-to-vehicle communication network, a road-to-road communication network, or the like.

The communication scheme in the wireless communication network may be a mobile communication scheme or a wireless data communication scheme. Examples of the mobile communication scheme include a 3G communication scheme, LTE communication scheme, 4G communication scheme, 5G communication scheme, and the like. Examples of the wireless data communication scheme include (i) a short-range wireless scheme such as Bluetooth (registered Trademark), Zigbee (registered Trademark), RFID such as NFC (Near Field Communication), infrared communication, visible light communication, and communication using sound waves or ultrasonic waves, (ii) a wireless LAN scheme such as WiFi (registered Trademark), (iii) a wireless MAN scheme such as WiMAX (registered Trademark), and (iv) a wireless WAN scheme, and the like.

In the present embodiment, the management server 110 manages the vehicle 120. The management server 110 may manage reservations for using the vehicle 120. The management server 110 may manage evaluations concerning the users of the vehicle 120. In the present embodiment, the management server 110 acquires, from a user who has used the vehicle 120, information indicating an evaluation concerning another user who has used the same vehicle 120 during the same period. The management server 110 may acquire in association with each other, from a user who has used the vehicle 120, information indicating an evaluation concerning another user who has used the same vehicle 120 during the same period and information indicating an activity condition of this other user during an interval in which this other user rode in the vehicle 120, or store these pieces of information in association with each other.

Examples of the activity condition include at least one of (i) information indicating whether this other user rode in the vehicle 120 alone, (ii) information indicating whether this other user rode in the vehicle 120 together with a related person of this other user, (iii) information indicating a relationship between this other user and this related person, and (iv) information indicating the number of these related people. Examples of the relationship between this other user and the related person include at least one of a family member, a relative, a friend, and an acquaintance. Examples of a family member include a parent, a child, a spouse, a sibling, and the like.

In the present embodiment, the vehicle 120 is used to transport people or objects. For example, the vehicle 120 picks up the user 20 and the related person 22 at a location indicated by the reservation 102. Furthermore, the vehicle 120 picks up the user 40 at the location indicated by the reservation 104. The vehicle 120 may be used for a shared bus, shared taxi, shared hire, or ride sharing application.

The vehicle 120 may be an autonomous driving vehicle, an unmanned driving vehicle, or a remote driving vehicle, or may be a manned driving vehicle. The vehicle 120 may, according to instructions from the management server 110, move to the location indicated by these instructions.

Examples of the vehicle 120 include a bicycle, an automobile, a motorcycle, a train, and the like. Examples of an automobile may include an engine vehicle, an electric vehicle, a fuel cell vehicle, a hybrid vehicle, a work machine, and the like. Examples of a motorcycle include (i) a motor bike, (ii) a three-wheel motor bike, and (iii) a standing two-wheeled or three-wheeled vehicle with a power unit, and the like.

In the present embodiment, the communication terminal 130 is an information processing apparatus used by the user 20, the user 40, or the user 60, and transmits and receives various types of information to and from each unit of the evaluation system 100, via the communication network 10. The communication terminal 130 may be used as a user interface for the evaluation system 100 or for part of the evaluation system 100.

The communication terminal 130 may be an information processing apparatus that has a communication function, and the details thereof are not particularly limited. Examples of the communication terminal 130 include a personal computer, a mobile terminal, and the like. Examples of a mobile terminal include a mobile phone, a smartphone, a PDA, a tablet, a notebook computer or a laptop computer, a wearable computer, and the like.

[Specific Configuration of Each Unit of the Evaluation System 100]

Each unit of the evaluation system 100 may be realized by hardware, by software, or by both hardware and software. At least part of each unit of the evaluation system 100 may be realized by a single server or by a plurality of servers. At least part of each unit of the evaluation system 100 may be realized on a virtual server or a cloud system. At least part of each unit of the evaluation system 100 may be realized by a personal computer or a mobile terminal. The mobile terminal can be exemplified by a mobile telephone, a smartphone, a PDA, a tablet, a notebook computer or a laptop computer, a wearable computer, and the like. Each unit of the evaluation system 100 may store information, using a distributed network or distributed ledger technology such as block chain.

If at least some of the components forming the evaluation system 100 are realized by software, these components realized by the software may be realized by starting up a program in which operations corresponding to these components are defined, with an information processing apparatus having a general configuration. The information processing apparatus having the general configuration described above may include (i) a data processing apparatus having a processor such as a CPU or a GPU, a ROM, a RAM, a communication interface, and the like, (ii) an input apparatus such as a keyboard, a pointing device, a touch panel, a camera, an audio input apparatus, a gesture input apparatus, various sensors, or a GPS receiver, (iii) an output apparatus such as a display apparatus, an audio output apparatus, or a vibration apparatus, and (iv) a storage apparatus (including an external storage apparatus) such as a memory, an HDD, or an SSD.

In the information processing apparatus having the general configuration described above, the data processing apparatus or the storage apparatus described above may store the program. The program causes the information processing apparatus described above to perform the operations defined by this program, by being executed by the processor. The program may be stored in a non-transitory computer readable storage medium. The program may be stored in a computer readable medium such as a CD-ROM, a DVD-ROM, a memory, or a hard disk, or may be stored in a storage apparatus connected to a network.

The program may be a program for causing the computer to function as the evaluation system 100 or a portion thereof. The program may include modules in which the operations of each unit of the evaluation system 100 are defined. This program or these modules act on the data processing apparatus, the input apparatus, the output apparatus, the storage apparatus, and the like to cause the computer to function as each unit of the evaluation system 100 and to cause the computer to perform the information processing method in each unit of the evaluation system 100.

The program may be installed in a computer forming at least part of the evaluation system 100, from the computer readable medium or the storage apparatus connected to the network. The computer may be caused to function as at least a portion of each unit of the evaluation system 100, by executing the program. By having the computer read this program, the information processes described in the program function as the specific means realized by the cooperation of software relating to these programs and various hardware resources of some or all of the evaluation system 100. These specific means realize computation or processing of the information corresponding to an intended use of the computer in the present embodiment, thereby forming the evaluation system 100 corresponding to this intended use.

The program may be a program for causing the computer to function as the management server 110. The program may be a program for causing the computer to execute the information processing method in the management server 110.

This information processing method includes, for example, an evaluation acquiring step of acquiring information indicating an evaluation of a person and information indicating an activity condition of the person during an evaluation target interval, in association with each other. Each step of the information processing method may be executed by the computer.

The evaluation system 100 may be an example of an information processing apparatus. The management server 110 may be an example of an information processing apparatus. The vehicle 120 may be an example of a moving body. The user 20, the related person 22, and the user 40 may be an example of a person. The user 20, the related person 22, and the user 40 may be an example of a passenger of the moving body. The user 20 may be an example of another person who evaluates the user 40. The related person 22 may be an example of a related person. The user 40 may be an example of another person who evaluates at least one of the user 20 and the related person 22. The interval during which the user 20 rode in the vehicle 120 may be an example of an evaluation target interval. The interval during which the user 40 rode in the vehicle 120 may be an example of an evaluation target interval.

In the present embodiment, an example of the evaluation system 100 is described in which the management server 110 functions as an evaluation acquiring unit that acquires information indicating an evaluation of a person and information indicating an activity condition of the person during an evaluation target interval, in association with each other, or as an information processing apparatus including this evaluation acquiring unit. However, the evaluation system 100 is not limited to the present embodiment.

In another embodiment, a computer loaded in the vehicle 120 may execute at least a portion of the information processing in the management server 110 according to the present embodiment. In this case, the computer of the vehicle 120 may be an example of an information processing apparatus.

In yet another embodiment, a computer loaded in the communication terminal 130 may execute at least a portion of the information processing in the management server 110 according to the present embodiment. In this case, the computer loaded in the communication terminal 130 may be an example of an information processing apparatus.

In the present embodiment, an example of the evaluation system 100 is described using an example of a case in which the evaluation system 100 manages evaluations concerning passengers of the vehicle 120 and an example of a case in which the evaluation system 100 performs a vehicle dispatch process. However, the evaluation system 100 is not limited to the present embodiment. In another embodiment, the evaluation system 100 may manage evaluations concerning passengers of any moving body.

Examples of the moving body include a vehicle, a ship, a flying body, and the like. Examples of a vehicle include a bicycle, an automobile, a motorcycle, and a train. Examples of a ship include a boat, a hovercraft, a personal watercraft, a submarine, a submersible, an underwater scooter, and the like. Examples of a flying body include an airplane, an airship, a balloon, a helicopter, a drone, and the like.

[Outline of the Management Server 110]

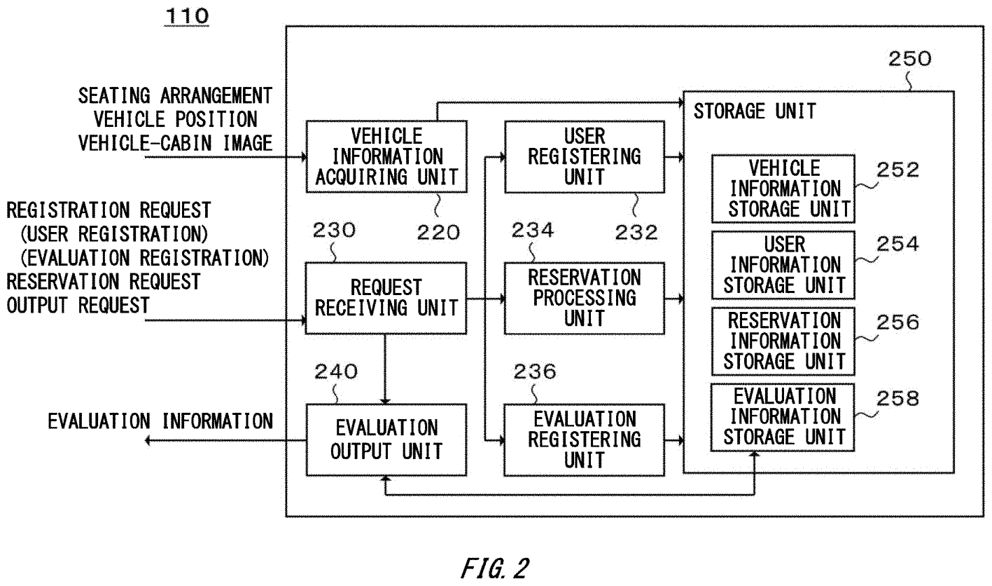

FIG. 2 schematically shows an example of an internal configuration of the management server 110. In the present embodiment, the management server 110 includes a vehicle information acquiring unit 220, a request receiving unit 230, a user registering unit 232, a reservation processing unit 234, an evaluation registering unit 236, an evaluation output unit 240, and a storage unit 250. In the present embodiment, the storage unit 250 may include a vehicle information storage unit 252, a user information storage unit 254, a reservation information storage unit 256, and an evaluation information storage unit 258.

In the present embodiment, the vehicle information acquiring unit 220 acquires various types of information concerning a vehicle 120, from each of one or more vehicles 120. For example, the vehicle information acquiring unit 220 acquires, from each of one or more vehicles 120, at least one of information indicating the current position of the vehicle 120, information indicating a movement history of the vehicle 120, image data of a vehicle-cabin image captured by the vehicle-cabin imaging unit 122, and information concerning specifications of the vehicle 120. Examples of the information concerning the specifications of the vehicle 120 include information indicating the seating arrangement in the vehicle 120, image data of a seating arrangement diagram of the vehicle 120, image data of an image of the outside of the vehicle 120, and the like. The vehicle information acquiring unit 220 may acquire, from a communication terminal used by the manufacturer or seller of each of the one or more vehicles 120, information concerning the specifications of the vehicle 120. The vehicle information acquiring unit 220 may store the various types of information concerning each of the one or more vehicles 120 in the vehicle information storage unit 252.

In the present embodiment, the request receiving unit 230 receives various types of requests made to the management server 110. The request receiving unit 230 determines an output destination of a request according to the type of the request received.

In one embodiment, the request receiving unit 230 acquires, from the communication terminal 130 of at least one of the user 20, the user 40, and the user 60, a user registration request for registering information concerning each user in the management server 110. The request receiving unit 230 may output the received user registration request to the user registering unit 232.

The user registration request may include various types of information concerning the user who transmitted this user registration request. Examples of the information concerning the user include identification information assigned to this user, information for identifying this user, communication address information of this user, bank account information of this user, and the like. The information for identifying this user may include information for identifying this user from the appearance of this user. For example, the information for identifying the user may be information indicating a physical characteristic unique to this user. Examples of the information indicating a physical characteristic unique to this user include image data of a face image of this user, data indicating feature points of the face of this user, and the like.

In another embodiment, the request receiving unit 230 acquires, from the communication terminal 130 of at least one of the user 20, the user 40, and the user 60, the evaluation registration request for registering an evaluation concerning another user in the management server 110. The request receiving unit 230 may output the received evaluation registration request to the evaluation registering unit 236.

The evaluation registration request may include information (sometimes referred to as an evaluation report) indicating an evaluation result of an evaluatee made by an evaluator. The evaluation report may include information for identifying the evaluatee and information indicating the evaluation of the evaluatee. Examples of the information for identifying the evaluatee include (i) information in which information for identifying the vehicle 120 and information for identifying at least a portion of a ride interval during which the evaluatee rode in the vehicle 120 are associated with each other, (ii) information in which information for identifying the vehicle 120, information for identifying at least a portion of a ride interval during which the evaluatee rode in the vehicle 120, and information for identifying a seating position of the evaluatee are associated with each other, (iii) information in which information for identifying the vehicle 120 and information for identifying a pickup location of the evaluatee are associated with each other, (iv) information in which information for identifying the vehicle 120, information for identifying a pickup location of the evaluatee, and information for identifying a pickup timing of the evaluatee are associated with each other, and the like.

The evaluation report may further include information indicating an activity condition of the evaluatee during the evaluation target interval. The evaluation report may further include information indicating the evaluation target interval. The evaluation report may further include identification information of a user who is the evaluator. The evaluation report may further include information for identifying a seating position of the user who is the evaluator.

In another embodiment, the request receiving unit 230 acquires, from the communication terminal 130 of at least one of the user 20, the user 40, and the user 60, the reservation request for reserving a ride in the vehicle 120. The request receiving unit 230 outputs the received reservation request to the reservation processing unit 234.

The reservation request may include information indicating a desired condition concerning the pickup location and information indicating a desired condition concerning the pickup timing. The reservation request may further include information indicating a desired condition concerning an evaluation of another passenger who is to ride in the vehicle 120. The reservation request may include identification information of a user who is to make a reservation to ride in the vehicle 120. The reservation request may include information indicating the number of related people who are to ride in the vehicle 120 along with this user. The reservation information may include information indicating the relationship between these related people and this user. The reservation request may include, for each of one or more related people, information indicating the relationship between this related person and this user.

In yet another embodiment, the request receiving unit 230 acquires, from the communication terminal 130 of at least one of the user 20, the user 40, and the user 60, an output request for browsing or acquiring an evaluation of the user themselves or another user. The request receiving unit 230 outputs the received output request to the evaluation output unit 240.

The output request may be a command causing the management server 110 to execute a procedure to output information indicating an evaluation of a specific person. The output request may be a command causing the management server 110 to execute a procedure to output information indicating an evaluation of a specific person under a specific activity condition. The output request may include information indicating this specific activity condition and information indicating this specific person.

In the present embodiment, the user registering unit 232 acquires the user registration request received by the request receiving unit 230. The user registering unit 232 stores the information that registration was requested by the user registration request in the user information storage unit 254.

In the present embodiment, the reservation processing unit 234 acquires the reservation request received by the request receiving unit 230. The reservation processing unit 234 extracts the vehicle 120 that matches the various types of desired conditions indicated by the reservation request, from among one or more vehicles 120 that are managed by the management server 110. The reservation processing unit 234 transmits, to the communication terminal 130 that transmitted the reservation request, a command causing a computer of the communication terminal 130 to execute a procedure for presenting the user with information concerning the extracted vehicle 120. Upon acquiring the information indicating that a reservation of the presented vehicle 120 has been made, from the communication terminal 130 that executed this command, the reservation processing unit 234 confirms the reservation of the vehicle 120.

In the above extraction process, if a plurality of vehicles 120 are extracted, the reservation processing unit 234 may select one or more vehicles 120 corresponding to the number of people indicated by the reservation request, from among the plurality of extracted vehicles 120, based on any standard. In another embodiment, the reservation processing unit 234 may transmit, to the communication terminal 130 that transmitted the reservation request, a command causing the computer of the communication terminal 130 to execute a process for selecting a vehicle 120 desired by this user, from among the plurality of vehicles 120. The reservation processing unit 234 may acquire information indicating a selection result of the user from this communication terminal 130, and select one or more vehicles 120 assigned to the reservation request, based on this selection result.

In the present embodiment, the evaluation registering unit 236 acquires the evaluation registration request received by the request receiving unit 230. The evaluation registering unit 236 determines an evaluation of the evaluatee, based on the evaluation report. Furthermore, the evaluation registering unit 236 identifies the user corresponding to the evaluatee, and associates the identification information of this user with the evaluation of the evaluatee, to generate information (sometimes referred to as evaluation information) concerning an evaluation of this user. The evaluation registering unit 236 stores the generated evaluation information in the evaluation information storage unit 258. The details of the evaluation registering unit 236 are described further below.

In the present embodiment, the evaluation output unit 240 acquires the output request received by the request receiving unit 230. The evaluation output unit 240 references the information stored in the evaluation information storage unit 258, and extracts the evaluation information that matches the condition indicated by the output request. For example, the evaluation output unit 240 extracts information indicating an evaluation of a specific user under an activity condition that matches the prescribed activity condition. The evaluation output unit 240 outputs the extracted evaluation information as a response to the above output request.

For example, the evaluation output unit 240 outputs information indicating an evaluation of the specific user. The evaluation output unit 240 may output the information indicating the evaluation of the specific user in association with each activity condition.

In the present embodiment, the storage unit 250 stores each type of information. The storage unit 250 may store information to be used in the information processing in the management server 110. The storage unit 250 may store information generated by the information processing in the management server 110.

In the present embodiment, the vehicle information storage unit 252 stores each type of information concerning each of one or more vehicles 120. The vehicle information storage unit 252 may store, for each vehicle 120, information concerning the vehicle 120 acquired by the vehicle information acquiring unit 220. For example, for each of the one or more vehicles 120, the vehicle information storage unit 252 stores at least one of information indicating the current position of the vehicle 120, information indicating a movement history of the vehicle 120, image data of a vehicle-cabin image captured by the vehicle-cabin imaging unit 122, and information concerning specifications of the vehicle 120, in association with the identification information of the corresponding vehicle. As described above, examples of the information concerning the specifications of the vehicle 120 include information indicating the seating arrangement in the vehicle 120, image data of a seating arrangement diagram of the vehicle 120, image data of an image of the outside of the vehicle 120, and the like.

In the present embodiment, the user information storage unit 254 stores each type of information concerning each of one or more users. For example, for each of the one or more users, the user information storage unit 254 may store at least one of information for identifying this user, communication address information of this user, and bank account information of this user, in association with the identification information assigned to this user. As described above, the information for identifying the user may include information for identifying this user from an appearance of this user.

In the present embodiment, the reservation information storage unit 256 stores information concerning the reservation confirmed by the reservation processing unit 234. Examples of the information concerning the reservation include identification information of the reservation, identification information of the reservation request corresponding to this reservation, identification information of the user who transmitted this reservation request, identification information of the vehicle 120 to which this reservation is assigned, information indicating a scheduled pickup location, information indicating a scheduled pickup timing, information indicating a scheduled drop-off location, and the like.

In the present embodiment, the evaluation information storage unit 258 stores the evaluation information generated by the evaluation registering unit 236. The evaluation information storage unit 258 may, in response to an extraction request from the evaluation output unit 240, extract the evaluation information that matches the condition indicated by this extraction request.

The request receiving unit 230 may be an example of an output request acquiring unit. The evaluation registering unit 236 may be an example of an information processing apparatus and an evaluation acquiring unit. The evaluation output unit 240 may be an example of an output unit. The evaluation information storage unit 258 may be an example of an information processing apparatus and an evaluation acquiring unit. The seating arrangement may be an example of a ride position.

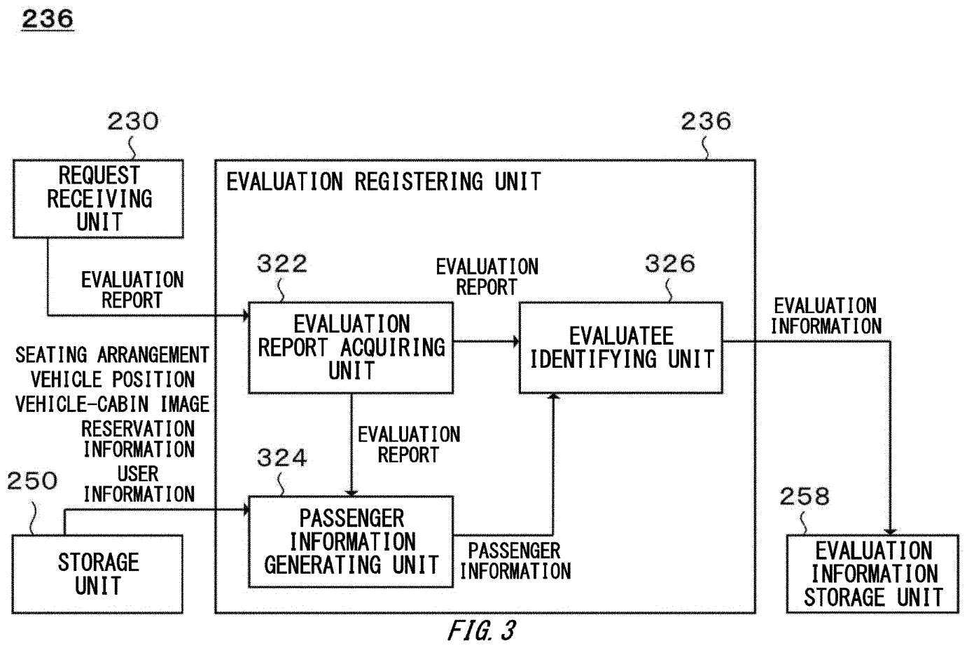

FIG. 3 schematically shows an example of an internal configuration of the evaluation registering unit 236. In the present embodiment, the evaluation registering unit 236 includes an evaluation report acquiring unit 322, a passenger information generating unit 324, and an evaluatee identifying unit 326.

In the present embodiment, in order to simplify the description, the details of the evaluation registering unit 236 are described using an example of a case in which the evaluation registration request is acquired from the user 40. According to the present embodiment, the evaluation report includes information indicating the evaluation result of a user 20 or a related person 22 made by the user 40. Furthermore, the evaluation report includes identification information of the user 40. The evaluation information may include information for identifying the evaluation target interval. Examples of the information for identifying the evaluation target interval include information indicating at least a portion of the ride interval of the user 40, identification information of the corresponding reservation, and the like.

In the present embodiment, the user 40 and the user 20 and related person 22 are strangers to each other, and the user 40 does not know the names or identification information of the user 20 and related person 22. Furthermore, it is difficult for the user 40 to identify who, among the user 20 and the related person 22, made the reservation to use the vehicle 120. Therefore, in the present embodiment, the user 40 identifies the user 20 or the related person 22 who is to be the evaluatee based on the seating arrangement.

In the present embodiment, the evaluation report acquiring unit 322 acquires the evaluation registration request received by the request receiving unit 230. The evaluation report acquiring unit 322 outputs the evaluation report included in the evaluation registration request to the passenger information generating unit 324 and the evaluatee identifying unit 326.

In the present embodiment, the passenger information generating unit 324 first identifies the vehicle 120 linked to the evaluation, based on the information included in the evaluation report. The passenger information generating unit 324 references the information stored in the storage unit 250, and identifies the passengers that rode in this vehicle 120 and the seating position of each passenger during the evaluation target interval. The passenger information generating unit 324 outputs information indicating the passengers who rode in this vehicle 120 and the seating position of each passenger to the evaluatee identifying unit 326.

In one embodiment, in a case where the seating position is designated at the time the reservation is made, the passenger information generating unit 324 references the reservation information stored in the reservation information storage unit 256, and identifies the passengers that rode in this vehicle 120 and the seating position of each passenger during the evaluation target interval. In this way, the identification information of the user 20 and the seating position of each of the user 20 and the related person 22 are identified.

In another embodiment, the passenger information generating unit 324 identifies the user 20 and the seating position of the user 20, based on the vehicle-cabin image stored in the vehicle information storage unit 252 and the face image of the user 20 stored in the user information storage unit 254. The passenger information generating unit 324 references the reservation information stored in the reservation information storage unit 256, and acquires the information indicating the number of related people 22 of the user 20. The passenger information generating unit 324 analyzes the vehicle-cabin image stored in the vehicle information storage unit 252 and identifies the number of passengers that have come to ride from the same pickup location as the user 20. As an example, if the number of passengers that have come to ride from the same pickup location as the user 20 matches the number of related people 22 indicated by the reservation information, the passenger information generating unit 324 judges that the passengers who have come to ride from the same pickup location as the user 20 are related people 22. Furthermore, the passenger information generating unit 324 identifies the seating positions of the related people 22, based on the vehicle-cabin image stored in the vehicle information storage unit 252.

In another embodiment, the passenger information generating unit 324 associates the group picked up from a specific location with the identification information of the user 20, based on the vehicle-cabin image and the position information of the vehicle 120 stored in the vehicle information storage unit 252 and the reservation information stored in the reservation information storage unit 256. Furthermore, the passenger information generating unit 324 identifies the seating position of each person in this group, based on the vehicle-cabin image stored in the vehicle information storage unit 252. In this way, the identification information of the user 20 and the seating positions of the user 20 and each related person 22 are identified.

In yet another embodiment, the passenger information generating unit 324 references the reservation information stored in the reservation information storage unit 256, and identifies the identification information of the user 20 who rode in this vehicle 120 during the evaluation target interval. Furthermore, if the request receiving unit 230 receives an evaluation registration request from the user 20 and the evaluation report from the user 20 indicates information indicating the seating position of the user 20, the passenger information generating unit 324 identifies the seating position of the user 20 based on the evaluation report from the user 20. Furthermore, in the same manner as in the procedure described above, the passenger information generating unit 324 may judge that passengers who have come to ride from the same pickup location as the user 20 are the related people 22. Furthermore, the passenger information generating unit 324 may identify the seating positions of the related people 22, based on the vehicle-cabin image stored in the vehicle information storage unit 252.

In the present embodiment, the evaluatee identifying unit 326 acquires the evaluation report made by the user 40 from the evaluation report acquiring unit 322. Furthermore, the evaluatee identifying unit 326 acquires information (sometimes referred to as passenger information) concerning the passengers who rode in the vehicle 120 corresponding to the evaluation report made by the user 40 from the passenger information generating unit 324.

The evaluatee identifying unit 326 identifies the evaluatee indicated by the evaluation report made by the user 40, based on the passenger information. The evaluatee identifying unit 326 may identify the user 20 associated with the evaluation result indicated by the evaluation report made by the user 40, based on the seating positions of the user 20 and the related person 22 indicated by the passenger information and the seating position of the evaluatee indicated by the evaluation report made by the user 40. Specifically, using the seating positions as a key, the user 20 and the related person 22 indicated by the passenger information and the evaluatee indicated by the evaluation report made by the user 40 are associated with each other.

If the evaluatee is the user 20, the evaluatee identifying unit 326 generates the evaluation information of the user 20 based on the evaluation report made by the user 40. Specifically, the evaluatee identifying unit 326 generates the evaluation information of the user 20 by associating the evaluation result of the user 20 with the activity condition that the user 20 is riding together with the related person 22.

If the evaluatee is the related person 22, the evaluation result of the related person 22 may be treated as an evaluation result of the user 20. Specifically, the evaluatee identifying unit 326 generates the evaluation information of the user 20 by associating with the evaluation result of the related person 22 with an activity condition that the user 20 is riding together with the related person 22.

If the evaluation result of the related person 22 is treated as an evaluation result of the user 20, a process may be performed to reduce the effect of the evaluation result of the related person 22 on the evaluation of the user 20. For example, in a case where the evaluation result is expressed as a numerical value, a numerical value obtained by multiplying the evaluation result of the related person 22 by a weighting coefficient that is greater than 0 and less than 1 may be used as the evaluation result of the user 20.

If the evaluatee is the related person 22 and user registration of the related person 22 has been completed, the evaluation result of the related person 22 may be treated as an evaluation result of the related person 22 themselves. Furthermore, in such a case, the evaluation information of the user 20 may be generated by associating the evaluation result of the related person 22 and an activity condition that the user 20 is riding together with the related person 22 with each other.

The evaluation report acquiring unit 322 may be an example of an evaluation acquiring unit. The passenger information generating unit 324 may be an example of an evaluation acquiring unit. The evaluatee identifying unit 326 may be an example of an information processing apparatus, an evaluation acquiring unit, and a person identifying unit.

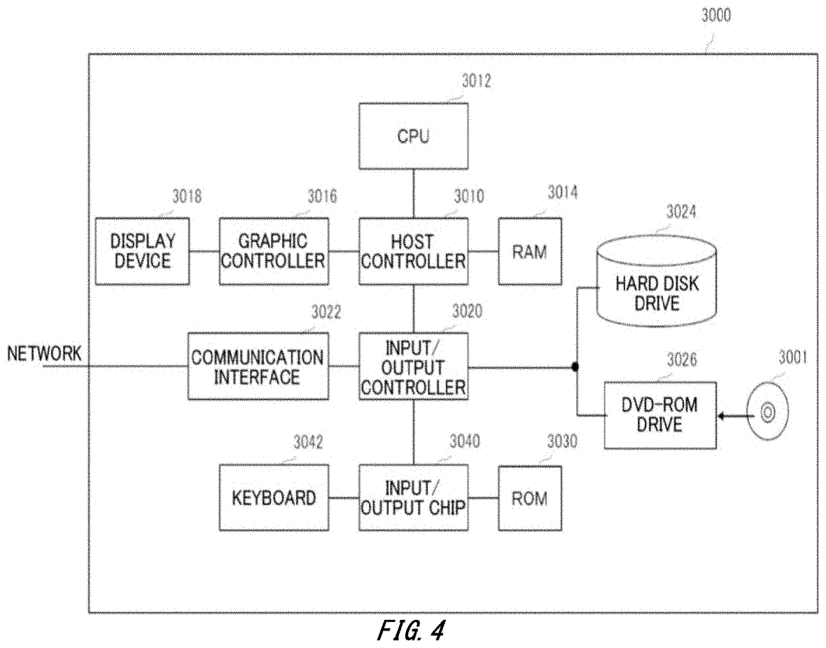

FIG. 4 shows an example of a computer 3000 in which aspects of the present invention may be wholly or partly embodied. The evaluation system 100 or a portion thereof may be realized by the computer 3000. For example, the management server 110 or a portion thereof is realized by the computer 3000.

A program that is installed in the computer 3000 can cause the computer 3000 to perform operations associated with apparatuses of the embodiments of the present invention or to function as one or more “units” thereof, and/or cause the computer 3000 to perform processes of the embodiments of the present invention or steps thereof. Such a program may be executed by the CPU 3012 to cause the computer 3000 to perform certain operations associated with some or all of the blocks of flowcharts and block diagrams described herein.

The computer 3000 according to the present embodiment includes a CPU 3012, a RAM 3014, a graphic controller 3016, and a display device 3018, which are mutually connected by a host controller 3010. The computer 3000 also includes input/output units such as a communication interface 3022, a hard disk drive 3024, a DVD-ROM drive 3026 and an IC card drive, which are connected to the host controller 3010 via an input/output controller 3020. The computer also includes legacy input/output units such as a ROM 3030 and a keyboard 3042, which are connected to the input/output controller 3020 through an input/output chip 3040.

The CPU 3012 operates according to programs stored in the ROM 3030 and the RAM 3014, thereby controlling each unit. The graphic controller 3016 obtains image data generated by the CPU 3012 on a frame buffer or the like provided in the RAM 3014 or in itself, and causes the image data to be displayed on the display device 3018.

The communication interface 3022 communicates with other electronic devices via a network. The hard disk drive 3024 stores programs and data used by the CPU 3012 within the computer 3000. The DVD-ROM drive 3026 reads the programs or the data from the DVD-ROM 3001, and provides the hard disk drive 3024 with the programs or the data via the RAM 3014. The IC card drive reads programs and data from an IC card, and/or writes programs and data into the IC card.

The ROM 3030 stores therein a boot program or the like executed by the computer 3000 at the time of activation, and/or a program depending on the hardware of the computer 3000. The input/output chip 3040 may also connect various input/output units via a parallel port, a serial port, a keyboard port, a mouse port, and the like to the input/output controller 3020.

A program is provided by computer readable media such as the DVD-ROM 3001 or the IC card. The program is read from the computer readable media, installed into the hard disk drive 3024, RAM 3014, or ROM 3030, which are also examples of computer readable media, and executed by the CPU 3012. The information processing described in these programs is read into the computer 3000, resulting in cooperation between a program and the above-mentioned various types of hardware resources. An apparatus or method may be constituted by realizing the operation or processing of information in accordance with the usage of the computer 3000.

For example, when communication is performed between the computer 3000 and an external device, the CPU 3012 may execute a communication program loaded onto the RAM 3014 to instruct communication processing to the communication interface 3022, based on the processing described in the communication program. The communication interface 3022, under control of the CPU 3012, reads transmission data stored on a transmission buffering region provided in a recording medium such as the RAM 3014, the hard disk drive 3024, the DVD-ROM 3001, or the IC card, and transmits the read transmission data to a network or writes reception data received from a network to a reception buffering region or the like provided on the recording medium.

In addition, the CPU 3012 may cause all or a necessary portion of a file or a database to be read into the RAM 3014, the file or the database having been stored in an external recording medium such as the hard disk drive 3024, the DVD-ROM drive 3026 (DVD-ROM 3001), the IC card, and the like, and perform various types of processing on the data on the RAM 3014. The CPU 3012 may then write back the processed data to the external recording medium.

Various types of information, such as various types of programs, data, tables, and databases, may be stored in the recording medium to undergo information processing. The CPU 3012 may perform various types of processing on the data read from the RAM 3014, which includes various types of operations, processing of information, condition judging, conditional branch, unconditional branch, search/replace of information, and the like, as described throughout this disclosure and designated by an instruction sequence of programs, and writes the result back to the RAM 3014. In addition, the CPU 3012 may search for information in a file, a database, and the like, in the recording medium. For example, when a plurality of entries, each having an attribute value of a first attribute associated with an attribute value of a second attribute, are stored in the recording medium, the CPU 3012 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable media on or near the computer 3000. In addition, a recording medium such as a hard disk or a RAM provided in a server system connected to a dedicated communication network or the Internet can be used as the computer readable media, thereby providing the program to the computer 3000 via the network.

While the embodiments of the present invention have been described, the technical scope of the invention is not limited to the above described embodiments. It is apparent to persons skilled in the art that various alterations and improvements can be added to the above-described embodiments. Features described in relation to a certain embodiment can be applied to the other embodiments, as long as this does not result in a technical contradiction. Each configurational element may have the same features as other configurational elements having the same name but different reference numerals. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### LIST OF REFERENCE NUMERALS

10: communication network, 20: user, 22: related person, 40: user, 60: user, 100: evaluation system, 102: reservation, 104: reservation, 110: management server, 120: vehicle, 122: vehicle-cabin imaging unit, 130: communication terminal, 220: vehicle information acquiring unit, 230: request receiving unit, 232: user registering unit, 234: reservation processing unit, 236: evaluation registering unit, 240: evaluation output unit, 250: storage unit, 252: vehicle information storage unit, 254: user information storage unit, 256: reservation information storage unit, 258: evaluation information storage unit, 322: evaluation report acquiring unit, 324: passenger information generating unit, 326: evaluatee identifying unit, 3000: computer, 3001: DVD-ROM, 3010: host controller, 3012: CPU, 3014: RAM, 3016: graphic controller, 3018: display device, 3020: input/output controller, 3022: communication interface, 3024: hard disk drive, 3026: DVD-ROM drive, 3030: ROM, 3040: I/O chip, 3042: keyboard

What is claimed is:

1. An information processing apparatus comprising:
an evaluation acquiring unit that acquires information indicating an evaluation of a person and information indicating an activity condition of the person during an evaluation target interval, in association with each other.

2. The information processing apparatus according to claim 1, wherein
the person is a passenger of a moving body, and
the evaluation target interval is an interval during which the person rode in the moving body.

3. The information processing apparatus according to claim 2, wherein
the information indicating the evaluation includes information indicating a result of another person who rode in the moving body during the evaluation target interval having evaluated the person.

4. The information processing apparatus according to claim 2, wherein
the information indicating the activity condition includes at least one of information indicating whether the person rode in the moving body alone and information indicating whether the person rode in the moving body together with a related person who has a relationship with the person.

5. The information processing apparatus according to claim 4, wherein
the information indicating the activity condition further includes at least one of information indicating a relationship between the person and the related person and information indicating the number of related people.

6. The information processing apparatus according to claim 5, wherein
the relationship between the person and the related person is at least one of a family member, a relative, a friend, and an acquaintance.

7. The information processing apparatus according to claim 2, wherein
the evaluation acquiring unit acquires the information indicating the evaluation of the person, the information indicating an activity condition of the person during the evaluation target interval, and information indicating a ride position of the person during the evaluation target interval, in association with each other.

8. The information processing apparatus according to claim 7, further comprising:
a passenger identifying unit that identifies at least some passengers in the moving body during the evaluation target interval and ride positions of the at least some passengers; and
a person identifying unit that identifies the person based on the ride position of each passenger in the moving body during the evaluation target interval identified by the passenger identifying unit and the ride position of the person during the evaluation target interval acquired by the evaluation acquiring unit.

9. The information processing apparatus according to claim 1, further comprising:
an output unit that references the information acquired by the evaluation acquiring unit and outputs information indicating an evaluation of a specific person.

10. The information processing apparatus according to claim 9, wherein
the output unit is configured to be capable of outputting the information indicating the evaluation of the specific person in association with each activity condition.

11. The information processing apparatus according to claim 9, further comprising:
an output request acquiring unit that acquires an output request for requesting output of the information indicating the evaluation of the specific person under a specific activity condition, wherein
the output unit, in response to the output request acquiring unit acquiring the output request, references the information acquired by the evaluation acquiring unit and extracts the information indicating the evaluation of the specific person under for which the activity condition matches the specific activity condition, and
the output unit outputs the extracted information as a response to the output request.

12. A non-transitory computer readable medium storing thereon a program, wherein
the program causes a computer to execute a method including evaluation acquisition of acquiring information indicating an evaluation of a person and information indicating an activity condition of the person during an evaluation target interval, in association with each other.

13. A method comprising:
evaluation acquisition of acquiring information indicating an evaluation of a person and information indicating an activity condition of the person during an evaluation target interval, in association with each other.
